(19) United States
(12) Patent Application Publication
(10) Pub. No.: US 2026/0104087 A1
(43) Pub. Date: Apr. 16, 2026

(54) DIFFERENTIAL LOCKING DEVICE FOR A DIFFERENTIAL GEAR

(71) Applicant: ZF Friedrichshafen AG, Friedrichshafen (DE)

(72) Inventor: Julian Lüftl, Tiefenbach (DE)

(73) Assignee: ZF Friedrichshafen AG, Friedrichshafen (DE)

(21) Appl. No.: 19/357,802

(22) Filed: Oct. 14, 2025

(30) Foreign Application Priority Data
Oct. 15, 2024 (DE) 10 2024 209 987.2

(51) Int. Cl. F16H 48/24; F16H 48/08; F16H 48/32

(52) U.S. Cl. CPC F16H 48/24; F16H 48/32; F16H 48/08

(57) ABSTRACT

A differential locking device is provided with a shifting element (20, 30) comprising a carrier (20) and a sliding sleeve (30). The carrier (20) has two carrier engagement sections (21, 22) a distance apart from one another in the axial direction. The sliding sleeve (30) has two sleeve engagement sections (31, 32) a distance apart from one another in the axial direction. In a locking switched condition, the carrier engagement sections (21, 22) and the sleeve engagement sections (31, 32) are engaged with one another. In an unlocking switched condition, one of the carrier engagement sections (21, 22) is arranged in the axial direction between the sleeve engagement sections (31, 32), and one of the sleeve engagement sections (31, 32) is arranged in the axial direction between the carrier engagement sections (21, 22).

### RELATED APPLICATIONS

This application claims the benefit of and right of priority under 35 U.S.C. § 119 to German Patent Application no. 10 2024 209 987.2, filed on 15 Oct. 2024, the contents of which are incorporated herein by reference in its entirety.

### TECHNICAL FIELD

The present invention relates to a differential locking device for a differential gear, a differential gearbox with a differential locking device, and a vehicle with a differential gearbox.

### BACKGROUND

Differential locking devices for a differential gear in vehicles are known. With the increasing complexity of vehicles and the increasing number of components and assemblies built into vehicles, a smaller fitting space of individual components and of the drive unit as a whole is advantageous.

### SUMMARY

A purpose of the present invention is to provide an improved differential locking device that takes up less fitting space.

This objective is achieved by a differential locking device as disclosed herein.

In a first aspect, a differential locking device for a differential gearbox is proposed. The differential gearbox comprises an input element, a first output element, and a second output element. The differential gearbox can be in the form of a bevel gear differential gearbox or a planetary differential gearbox. The differential gearbox can comprise a first gearset element, at least one or for example two or four second gearset elements, and two third gearset elements. The differential locking device comprises a shifting element with a carrier and a sliding sleeve. The carrier is designed for a rotationally fixed connection with any one of the input element, the first output element, or the second output element. The carrier comprises carrier engagement sections spaced a distance apart from one another in the axial direction. The sliding sleeve is designed for a rotationally fixed connection with another one of either the input element, or the first output element or the second output element. The carrier can be designed for a rotationally fixed connection with the input element. Then the sliding sleeve can be designed for a rotationally fixed connection with either of the first output element and the second output element. The sliding sleeve is designed to be movable in the axial direction relative to the input element, the first output element, and the second output element. The sliding sleeve comprises two sleeve engagement sections a distance apart from one another in the axial direction.

The carrier engagement sections and the sleeve engagement sections are arranged so that the shifting element provides a locking switched condition and an unlocking switched condition. In the locking switched condition, the carrier engagement sections and the sleeve engagement sections are engaged. In the unlocking switched condition, one of the carrier engagement sections is arranged in the axial direction between the sleeve engagement sections, and one of the sleeve engagement sections is arranged between the carrier switch sections in the axial direction.

If two elements are mechanically functionally connected, then they are directly or indirectly coupled with one another in such manner that a movement of one element brings about a reaction of the other element. For example, a mechanical functional connection can be produced by an interlocked or friction-force-locked connection. The mechanical functional connection can correspond to the meshing of corresponding teeth of the two elements. Between the elements further elements can be provided, for example one or more spur gear stages. In contrast, a permanent rotationally fixed connection between two elements is understood to mean a connection in which the two elements are coupled solidly to one another in all the intended conditions of the transmission. In that case, the elements can be in the form of individual components connected to one another, or even ones made integrally. On the other hand, by means of a shifting element, a rotationally fixed connection can be selectively made, or released or broken between two elements.

The sliding sleeve can have two switched positions. One switched position can be a locking position in which the shifting element is closed. In the locking position, a rotationally fixed connection can be formed between the sliding sleeve and the carrier. One switched position can be an unlocking position in which the shifting element is open, In the unlocking position, a rotationally fixed connection between the sliding sleeve and the carrier can be released. The sliding sleeve can be moved in a first direction, for example the axial direction, in such manner that it can be brought to the locking position. The sliding sleeve can be moved, for example in the direction opposite to the first direction, in such manner that the sliding sleeve can be brought to the unlocking position.

The first output element and the second output element can be arranged coaxially. The first output element and the second output element can extend in the axial direction on opposite sides. The first output element and the second output element can be arranged rotatably about the same rotation axis. The rotation axis can be directed in the axial direction. A radial direction can be directed perpendicularly to the axial direction. A circumferential direction can extend around the axial direction. The carrier and the sliding sleeve can be arranged coaxially with the rotation axis.

The sleeve engagement sections and the carrier engagement sections can be positioned in such manner that for the unlocking switched condition an annular gap is provided with a meander-shaped cross-section surface in the circumferential direction between the sliding sleeve and the carrier. By moving the sliding sleeve in the axial direction, the shifting element can be locked or unlocked, as desired. In that way, the switching path between the locking condition and the unlocking condition is shorter.

The input element can be connected rotationally fixed to the first gearset element, for example an input bevel gear. The input element can be in the form of a differential cage. The input element can comprise the first gearset element. The second gearset element, for example a compensating bevel gear, and the third gearset elements, for example output bevel gears, can be mounted rotatably on the input element. The second gearset element can be engaged with the third gearset elements. The first and second output elements can be in the form of shafts, for example stub shafts. The first output element can be connected rotationally fixed, for example by way of a shaft-hub connection such as a spline-shaft or splined-shaft connection, to one of the third gearset elements. The second output element can be connected rotationally fixed, for example by way of a shaft-hub connection such as a spline-shaft or splined-shaft connection, to the other one of the third gearset elements.

The carrier can be connected rotationally fixed, for example to the input element, by means of a flange located radially on the outside. The carrier can be, for example, welded to the input element. The carrier can be connected rotationally fixed, for example to the input element, by a shaft-hub connection such as a spline-shaft or splined-shaft connection, a screw joint or the like. The carrier and for example the input element can be made integrally. The carrier can comprise a first carrier engagement section and a second carrier engagement section, or more. The carrier engagement sections can each be arranged offset relative to one another by the same amount in the axial direction. The carrier engagement sections can each have the same engagement contour, for example a hub profile of a splined-shaft connection.

In an embodiment of the differential locking device, in each case one of the carrier engagement sections can be formed on an inner circumference of the carrier. In each case one of the sleeve engagement sections can be formed on an outer circumference of the sliding sleeve.

The carrier engagement section can be designed as a hub profile of a shaft-hub connection, such as a spline-shaft or a splined-shaft connection. The sleeve engagement section can be designed as a spline-shaft or a splined-shaft connection. By virtue of the structure of the rotationally fixed connection between the sliding sleeve and the carrier as a shaft-hub connection, large forces can be transmitted. In that way a differential locking device that takes up little fitting space in the radial direction can be provided.

In an embodiment of the differential locking device, one of the carrier engagement sections and the sleeve engagement sections can comprise an insertion section for inserting one of the sleeve engagement sections in the axial direction into one of the carrier engagement sections.

Both one of the carrier engagement sections and also one of the sleeve engagement sections can comprise an insertion section, for example a carrier insertion section or a sleeve insertion section. The insertion section can be in the form of a curvature, for example on an end surface of a tooth or wedge geometry in the axial direction. Each of the teeth or wedges of one of the carrier engagement sections or one of the sleeve engagement sections can have an insertion section. In that way a blockage of the movement of the sliding sleeve to the locking position, for example due to a tooth-on-tooth contact between the sliding sleeve and the carrier, is prevented.

The carrier engagement sections and the sleeve engagement sections can be positioned and/or designed in such manner that during the closing movement, first those carrier engagement sections and sleeve engagement sections which have an insertion section come into engagement with one another. For example, the sleeve engagement sections can have a smaller distance between them in the axial direction than the carrier engagement sections, or vice-versa. For example, an extension in the axial direction of the carrier engagement sections and/or of the sleeve engagement sections which have the insertion section can be greater than the extension in the axial direction of the carrier engagement sections and/or the sleeve engagement sections which do not have the insertion section. In that way the sliding sleeve can be aligned relative to the carrier before the sliding sleeve is fully engaged with the carrier. This can result in greater shifting comfort.

In an embodiment of the differential locking device, an annular piston for the actuation of the shifting element can be arranged so that it can move in the axial direction. The annular piston can be coupled to the sliding sleeve. The annular piston can be coupled to the sliding sleeve in such manner that a movement of the annular piston in the axial direction brings about a movement of the sliding sleeve in the axial direction. The annular piston can be arranged coaxially with the rotation axis.

The annular piston can be designed such that it at least partially envelops the sliding sleeve and the carrier in the radial direction. The annular piston can be arranged in a gap between the shifting element and a stationary component such as a gearbox housing. The annular piston can have a stepped shape. The annular piston, the carrier and the sliding sleeve can be stacked in the radial direction. The annular piston, the carrier and the sliding sleeve can have a nested structure. In that way a differential locking device that takes up little space in the radial direction and the axial direction is produced. The annular piston can be fitted in the stationary component so that it can move axially. The annular piston can be fitted in the stationary component by way of a sliding surface, for example an outer sliding surface, for example on an internal circumference. By means of the sliding surface the annular piston can be positioned in the radial direction.

In an embodiment of the differential locking device, the annular piston can be coupled to the sliding sleeve via a bearing unit.

The bearing unit can comprise a radial bearing, for example a deep-groove ball bearing. The bearing unit can comprise an axial bearing. The bearing unit can be arranged coaxially with the annular piston. In that way a differential locking device that takes up little space in the radial direction and in the axial direction is produced. Moreover, in that way a differential locking device with low friction losses during a switching process is obtained. The result is a more comfortable switching process, even when the switching process is carried out during a rotation of the sliding sleeve and therefore also of the first output element or the second output element.

In an embodiment of the differential locking device, the annular piston can comprise a fluid pressure surface which is designed to move the annular piston to a first side in the axial direction when a fluid pressure, for example air pressure or oil pressure, is applied. In that way the shifting element can for example be closed.

By way of the fluid pressure a fluid force can be produced on the annular piston. The movement of the annular piston or the sliding sleeve can bring about the closing movement of the sliding sleeve. The annular piston can be designed to be actuated hydraulically or pneumatically. Together with a surface of the stationary component, the fluid pressure surface of the annular piston can form a fluid space. The fluid space can be designed to receive a pressurized fluid, for example air or oil. The fluid pressure surface can be in the form of a chamfer, for example on an outer circumference, for example adjacent to the sliding surface of the annular piston.

The sliding sleeve can have a sleeve contact surface. The annular piston, the bearing unit and the sliding sleeve can then be designed to be moved in the axial direction in the direction of the first side until the sleeve contact surface comes into contact with the input element. The sleeve contact surface can be associated with the locking position of the sliding sleeve.

In an embodiment of the differential locking device, the annular piston can have a spring contact surface which is designed, when a spring force of a spring unit is applied in the axial direction, to move the annular piston in the direction of a second side. The second side can be directed oppositely to the first side. In that way, for example the shifting element can be opened.

In this case a direct force flow of actuating forces can be provided, for example the fluid force and/or the spring force. Both the fluid force and the spring force can act directly upon the annular piston. A movement of the annular piston can be transmitted directly to the sliding sleeve, for example by way of the bearing unit. In that way a more comfortable and reliable switching process can take place.

The spring contact surface can be arranged on an end section in the axial direction on the first side. The spring contact surface can be formed by a depression in the axial direction. The spring contact surface can be formed as a ring in the circumferential direction. The spring contact surface can be designed to receive a section of at least one of the spring elements of the spring unit. The spring contact surface can be made cylindrical in the axial direction. A plurality of cylindrical spring contact surfaces can be arranged in the circumferential direction, for example uniformly distributed.

The spring unit can comprise spring elements. A spring element can be in the form of a spiral spring, for example an axial compression spring. The spring elements can be arranged in the circumferential direction, for example distributed uniformly. The spring elements can be arranged in the circumferential direction radially symmetrically relative to the rotation axis. The spring elements can be designed to be compressed in the axial direction. By virtue of the spring contact surface the spring elements can be integrated into existing components, such as the annular piston, or into an existing fitting space such as the radial fitting space for the carrier. In that way a differential locking device occupying little space in the axial and radial directions can be obtained. Furthermore, the spring elements can be designed to be fitted into the annular piston independently of the sliding sleeve, or can be designed to be fitted into the stationary component. This facilitates the assembly of the differential locking device as a whole.

In an embodiment of the differential locking device, the spring unit can be arranged in the radial direction outside the sliding sleeve and the carrier engagement sections,

The spring unit can be arranged in the radial direction outside of an outer circumference of the carrier. The spring unit can be arranged in the axial direction in the same plane as the shifting element and the carrier. The spring unit can extend in the axial direction in the shape of a ring. The spring unit can be arranged coaxially with the rotation axis. In that way the differential locking device takes up little fitting space in the axial direction.

In an embodiment of the differential locking device, the spring unit can comprise a supporting element which is designed to support spring elements in the axial direction against the stationary component.

The supporting element can be designed in the shape of a ring. The supporting element can be arranged coaxially with the rotation axis. The supporting element can be arranged in the axial direction in the same plane as the sliding sleeve and the carrier. The supporting element can be arranged in the radial direction outside the sliding sleeve and the carrier engagement sections. The supporting element can be arranged in the axial direction offset relative to the annular piston. The supporting element can be held in contact with the stationary component in the axial direction by means of a locking ring. The supporting element can be positioned in the radial direction by means of an outer circumference against an inner circumference of the stationary component.

The supporting element can comprise a spring contact surface for receiving a section of at least one of the spring elements. The spring contact surface can be formed by a depression in the axial direction. The spring contact surface can be ring-shaped in the circumferential direction. A plurality of cylindrical spring contact surfaces can be arranged in the circumferential direction, for example distributed uniformly. The spring contact surface of the annular piston and the spring contact surface of the supporting element can be arranged facing one another in the axial direction. The spring elements can be arranged in the axial direction between the spring contact surface of the annular piston and the spring contact surface of the supporting element.

By virtue of the movement of the annular piston under the action of the fluid pressure, the compression spring can be designed to be compressed. The spring force can produce a restoring force toward the second side, for example away from the input element. The annular piston can comprise a piston contact surface. The piston contact surface can be made ring-shaped. When the fluid force is smaller than the restoring force, the annular piston can be moved toward the second side, for example until the piston contact surface comes into contact with the stationary component. The piston contact surface can limit the fluid space and can be adjacent to the fluid space. In that way the annular piston can be moved easily in the axial direction away from the piston contact surface, for example without appreciable adhesion to the piston contact surface. This also applies when air is used as the fluid.

In a second aspect, a differential gearbox is provided with a differential locking device according to any of the preceding embodiments. In this case, the differential gearbox can comprise an integrated interlocking differential lock. Further features, effects, and advantages of the second aspect can emerge from the first aspect. Moreover, features, effects and advantages of the second aspect also constitute features, effects, and advantages of the first aspect. The differential gearbox comprises an input element, a first output element, and a second output element. The input element is designed for the input of a driving force into the differential gearbox. The differential gearbox is designed to divide the driving force from the input element between the first output element and the second output element.

The differential gearbox can be designed as a bevel differential gearbox or a planetary differential gearbox. The differential gearbox can comprise a first gearset element, for example an input bevel gear, at least one second gearset element, for example an equalization bevel gear or four second gearset elements, and two third gearset elements, for example two output bevel gears, as described above. In each case, one of the third gearset elements can be connected rotationally fixed to one of the first output element and the second output element. For example, one of the third gearset elements can be connected rotationally fixed to the first output element and the other one of the third gearset elements can be connected rotationally fixed to the second output element.

In an embodiment of the differential gearbox, the differential gearbox can be in the form of a bevel gear differential gearbox.

The input element can be in the form of a differential cage. The first gearset element can be designed as an input bevel gear. The input bevel gear can be connected rotationally fixed to the differential cage. The second gearset element can be designed as an equalization bevel gear. The differential gearbox can comprise four equalization bevel gears, arranged in the shape of a star. The third gearset elements can be designed as output bevel gears. The equalization bevel gears can mesh with the output bevel gears. The equalization bevel gears and the output bevel gears can be mounted rotatably on the differential cage.

In a third aspect, a vehicle with a differential gearbox according to any of the embodiments of the second aspect is provided. The vehicle can be a passenger car or a utility vehicle such as a working machine. Further features, effects, and advantages of the third aspect can emerge from the second aspect. Moreover, features, effects, and advantages of the third aspect are also features, effects, and advantages of the second aspect. The vehicle comprises a drive unit with a driveshaft for generating a drive power, which shaft is functionally connected to the input element of the differential gearbox. The drive unit can comprise a motor, for example an internal combustion engine or an electric motor. The driveshaft of the drive unit can be connected rotationally fixed to the input element of the differential gearbox. The vehicle has two drive elements, one of the drive elements being mechanically functionally connected to the first output element and the other drive element being mechanically functionally connected to the second output element in order to drive the vehicle.

The drive elements can be in the form of wheels or chain drives. Each of the first and second output elements can be mechanically functionally connected, respectively, to one of the drive elements, for example rotationally fixed thereto. Between the first and second output element and the corresponding drive element, driveshafts for providing a steering angle or a spring deflection can be provided.

### BRIEF DESCRIPTION OF THE FIGURES

FIG. 1 shows a sectioned view of an embodiment of a differential locking device for a differential gearbox.

FIG. 2 shows a sectioned view of the embodiment of the differential locking device.

FIG. 3 shows a perspective view of an embodiment of a carrier of the differential locking device.

FIG. 4 shows a perspective view of an embodiment of a sliding sleeve of the differential locking device.

FIG. 5 shows a view from above, illustrating the principle of an embodiment of the vehicle with the drive unit.

### DETAILED DESCRIPTION OF EMBODIMENTS

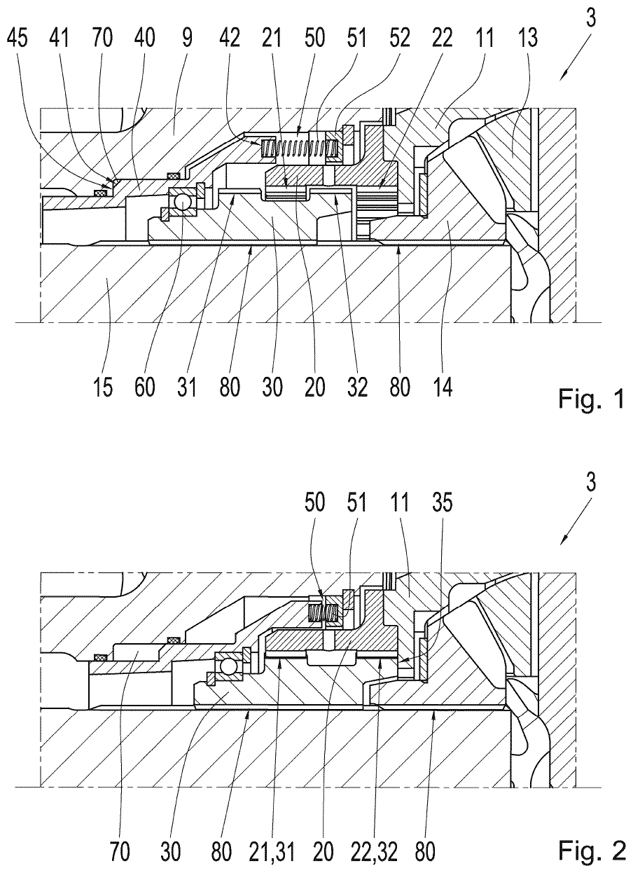

FIG. 1 shows a sectioned view of an embodiment of a differential locking device for a differential gearbox 3. The differential gearbox 3 comprises an input element 11, in this case a differential cage, a first output element 15, in this case a stub shaft, and a second output element 16 (not shown), in this case a further stub shaft. The differential gearbox is designed to divide a drive power from the input element 11 between the first output element 15 and the second output element 16. The drive power is supplied by a drive unit (not shown), for example an electric motor. FIG. 1 shows the differential locking device in an unlocking switched condition.

The differential locking device comprises a shifting element 20, 30 with a carrier 20 and a sliding sleeve 30. The carrier 20 is connected by means of a flange, rotationally fixed to the input element 11, and in this case welded to the input element 11. On an inner circumference the carrier 20 comprises two carrier engagement sections 21, 22 a distance apart from one another in the axial direction. The carrier engagement sections 21, 22 are in the form of a shaft profile of a splined-shaft connection and have the same carrier contour. The carrier 20 is arranged coaxially with a rotation axis of the first output element 15.

The sliding sleeve 30 is connected rotationally fixed by a shaft-hub connection, in this case a splined-shaft connection, at an inner circumference to the first output element 15 and can be moved in the axial direction relative to the first output element 15. On an outer circumference the sliding sleeve 30 has two sleeve engagement sections 31, 32 a distance apart from one another in the axial direction. The sleeve engagement sections 31, 32 are each in the form of a hub profile of a splined-shaft connection and have the same carrier contour. The sliding sleeve 30 is arranged coaxially with a rotation axis of the first output element 15. The sliding sleeve 30 is arranged in the radial direction between the carrier 20 and the first output element 15.

The shifting element 20, 30 has a locking switched condition and an unlocking switched condition. By moving the sliding sleeve 30 in the axial direction the shifting element 20, 30 can optionally be locked or unlocked. In the locking switched condition the carrier engagement sections 21, 22 and the sleeve engagement sections 31, 32 are engaged with one another. The input element 11 is then connected rotationally fixed to the first output element 15 by the carrier 20 and the sliding sleeve 30. In that way the differential gearbox 3 is locked and the first output element 15 is connected rotationally fixed to the second output element. In the unlocked switched condition, the sliding sleeve 30 together with the first output element 15 can rotate about the rotation axis relative to the carrier 20 and relative to the input element 11. Then, the first output element 15 can rotate about the rotation axis relative to the second output element 16. In the unlocked switched condition a first carrier engagement section 21 is positioned in the axial direction between the two sleeve engagement sections 31, 32. In the unlocked condition, a second sleeve engagement section 32 is positioned in the axial direction between the two carrier engagement sections 21, 22. In the unlocked condition, a meander-shaped annular gap is provided between the carrier 20 and the sliding sleeve 30. This results in a shorter switching path for the sliding sleeve 30 between the locked switched condition and the unlocked switched condition.

Below, further advantages of the differential locking device and the differential gearbox 3 are described.

An annular piston 40 is arranged and can be moved in the axial direction on a cylindrical outer sliding surface in a stationary component 9, in this case a gearbox housing, and coaxially with the rotation axis of the first output element 15. In the radial direction the annular piston 40 at least partially envelops the carrier 20 and the sliding sleeve 30. In the unlocked switched condition, the annular piston 40 rests with a piston contact surface 45 against the stationary component 9. The sliding sleeve 30 is positioned in the unlocking position. The annular piston 40 has a fluid pressure surface 41. The fluid pressure surface 41 has a chamfer which, with the stationary component 9, forms in the unlocked switched condition a fluid space 70, in this case for air. If there is a fluid pressure in the fluid space 70, then the annular piston 40 is pushed in the axial direction by a fluid force toward a first side, namely toward the right in FIG. 1. During this action, the piston contact surface 45 moves away in the axial direction from the stationary component 9 and the fluid space 70 becomes larger. The annular piston 40 is coupled to the sliding sleeve 30 by a bearing unit 60, in this case a radial deep-groove ball bearing. In that way the movement of the annular piston 40 in the axial direction is transmitted to the sliding sleeve 30. The shifting element 20, 30 can be actuated by the annular piston 40. The sliding sleeve 30 can rotate about the rotation axis relative to the annular piston 40 without appreciable friction losses.

A spring unit 50 is provided at an end of the annular piston 40 on the first side. The spring unit 50 comprises a plurality of spring elements 51, in this case axial compression springs which are arranged distributed uniformly and radially symmetrically in the circumferential direction. On an end section on the first side, the annular piston 40 has a spring contact surface 42 which has cylindrical recesses for receiving the plurality of spring elements 51. Via the spring contact surface 42, a spring force acts upon the annular piston 40 toward a second side, namely, the left side in FIG. 1. If the fluid force is smaller than the spring force, then the annular piston 40 is pushed in the axial direction toward the second side until the piston contact surface 45 comes into contact with the stationary component 9.

The spring unit 50 comprises an annular supporting element 52 arranged in the radial direction outside of the sliding sleeve 30 and the carrier engagement sections 21, 22 and coaxially with the rotation axis of the first output element 15. The supporting element 52 forms a spring contact surface for receiving the plurality of spring elements 51. The spring contact surface 42 of the annular piston 40 and the spring contact surface of the supporting element 52 are arranged facing toward one another in the axial direction. The plurality of spring elements 51 are arranged in the axial direction between the spring contact surface 42 of the annular piston 40 and the spring contact surface of the supporting element 52. The supporting element 52 is positioned with an outer circumference on the stationary component 9. The supporting element 52 is kept in contact with the stationary component 9 by means of a locking ring. In that way the supporting element 52 can support the spring force in the axial direction on the stationary component 9.

The differential gearbox 3 is in this case in the form of a bevel gear differential gearbox. The differential gearbox 3 comprises a first gearset element 12 (not shown), in this case an input bevel gear, four second gearset elements 13, in this case compensating gears, and two third gearset elements 13, in this case output bevel gears. The second gearset elements 13 and the third gearset elements 14 mesh with one another. One of the third gearset elements 14 is connected rotationally fixed by means of a shaft-hub connection 80 to the first output element 15. The other one of the third gearset elements 14 is connected rotationally fixed by means of a shaft-hub connection 80 to the second output element 16.

FIG. 2 shows a sectioned view illustrating the principle of the embodiment of the differential locking device. FIG. 2 shows the differential locking device in a locking switched condition. The sliding sleeve 30 is pushed toward the first side, until a sleeve contact surface 35 comes into contact with the input element 11. The sliding sleeve 30 is positioned in the locking position. The carrier engagement sections 21, 22 are engaged with the sleeve engagement sections 31, 32. The spring elements 51 of the spring unit 50 are compressed in the axial direction. The fluid space 70 is made larger.

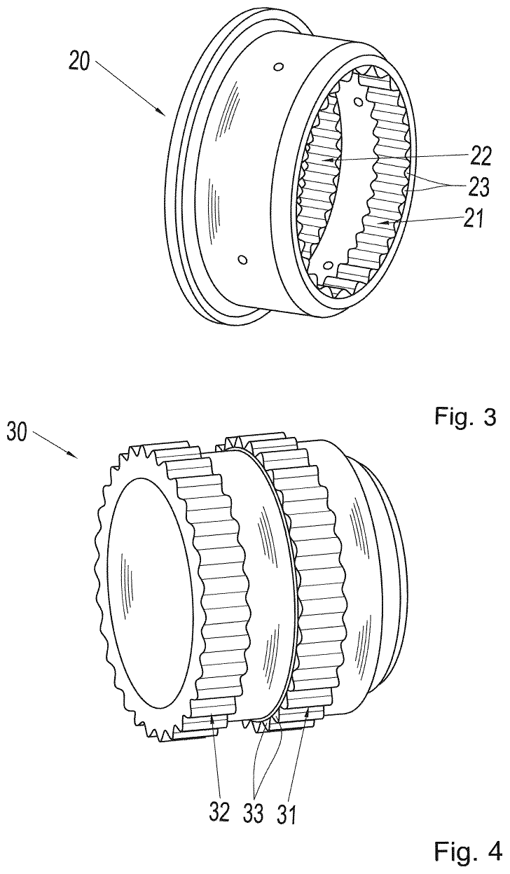

FIG. 3 shows a perspective view of an embodiment of the carrier 20 of the differential locking device. At its end on the second side in the axial direction the first carrier engagement section 21 has a plurality of carrier insertion sections 23. The carrier insertion sections 23 are in the form of curvatures on the end face in the axial direction of each tooth of the hub profile.

FIG. 4 shows a perspective view of an embodiment of the sliding sleeve 30 of the differential locking device. The first sleeve engagement section 31 has at its end face in the axial direction on the first side a plurality of sleeve insertion sections 33. The sleeve insertion sections 33 are in the form of curvatures on the end face in the axial direction of each tooth of the shaft profile.

In an embodiment of the differential locking device, the first carrier engagement section 21 and the first sleeve engagement section 31 are each provided with a respective insertion section 23, 33, in each case on sides of the first carrier engagement section 21 and of the first sleeve engagement section 31 that face toward one another. In that way, when the sliding sleeve 30 moves from the unlocking position to the locking position the insertion sections 23, 33 are first brought into engagement and the sliding sleeve 30 is aligned in the circumferential direction relative to the carrier 20. Then, the sleeve engagement sections 31, 32 are brought into engagement with the carrier engagement sections 21, 22. In that way a tooth-on-tooth contact between the sliding sleeve 30 and the carrier 20 when the sliding sleeve 30 moves from the unlocking position to the locking position is prevented.

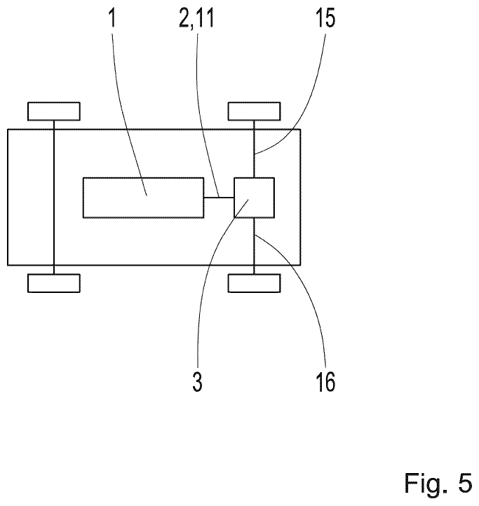

FIG. 5 shows a view from above, illustrating the principle of an embodiment of a vehicle with the differential gearbox 3. The vehicle comprises a drive unit 1 with a motor. The motor has a driveshaft 2 which is connected rotationally fixed to the input element 11. The first output element 15 and the second output element 16 are each connected rotationally fixed by means of universal joint shafts to drive elements of the vehicle, in this case wheels, for the propulsion of the vehicle.

### INDEXES

1 Drive unit
2 Driveshaft
3 Differential gearbox
9 Stationary component
11 Input element
13 Second gearset element
14 Third gearset element
15 First output element
16 Second output element
20 Carrier
21 First carrier engagement section
22 Second carrier engagement section
23 Carrier insertion section
30 Sliding sleeve
31 First sliding sleeve engagement section
32 Second sliding sleeve engagement section
33 Sliding sleeve insertion section
35 Sliding sleeve contact surface
40 Annular piston
41 Fluid pressure surface
42 Spring contact surface
45 Piston contact surface
50 Spring unit
51 Spring element
52 Supporting element
60 Bearing unit
70 Fluid space
80 Shaft-hub connection

1. A differential locking device for a differential gearbox (3) having an input element (11), a first output element (15), and a second output element (16), wherein the differential locking device comprises:
a shifting element (20, 30) with a carrier (20) and a sliding sleeve (30), the carrier (20) configured for a rotationally fixed connection with one of the input element (11), the first output element (15), or the second output element (16), and comprises two carrier engagement sections (21, 22) a distance apart from one another in the axial direction;
wherein the sliding sleeve 30 is configured to be connected rotationally fixed with and to be movable in the axial direction toward another one of the input element (11), the first output element (15), or the second output element (16), and comprises two sleeve engagement sections (31, 32) a distance apart from one another in the axial direction; and
wherein the carrier engagement sections (21, 22) and the sleeve engagement sections (31, 32) are arranged in such manner that the shifting element (20, 30) provides a locking switched condition in which the carrier engagement sections (21, 22) and the sleeve engagement sections (31, 32) are engaged with one another, and provides an unlocking switched condition in which one of the carrier engagement sections (21, 22) is arranged in the axial direction between the sleeve engagement sections (31, 32) and one of the sleeve engagement sections (31, 32) is arranged in the axial direction between the carrier engagement sections (21, 32).

2. The differential locking device according to claim 1, wherein each of the carrier engagement sections (21, 22) is formed at an inner circumference of the carrier (20) and one of the sleeve engagement sections (31, 32) is formed on an outer circumference of the sliding sleeve (30).

3. The differential locking device according to claim 1, wherein one of the carrier engagement sections (21, 22) and the sleeve engagement sections (31, 32) has an insertion section (23, 33) for inserting one of the sleeve engagement sections (31, 32) in the axial direction into one of the carrier engagement sections (21, 32).

4. The differential locking device according to claim 1, comprising:
an annular piston (40) coupled to the sliding sleeve (30) and arranged so that it can move in the axial direction for an actuation of the shifting element (20, 30).

5. The differential locking device according to claim 4, wherein the annular piston (40) is coupled to the sliding sleeve by means of a bearing unit (60).

6. The differential locking device according to claim 4, wherein the annular piston (40) has a fluid pressure surface (41), configured, when a fluid pressure acts upon it, to move the annular piston (40) in the axial direction toward a first side.

7. The differential locking device according to claim 4, wherein the annular piston (40) has a spring contact surface (42), configured, when a spring force of a spring unit (50) acts upon it, to move the annular piston (40) in the axial direction toward a second side.

8. The differential locking device according to claim 7, wherein the spring unit (50) is arranged in the radial direction outside the sliding sleeve and the carrier engagement sections.

9. The differential locking device according to claim 7, wherein the spring unit (50) comprises a supporting element (52) configured to support spring elements (51) in the axial direction against a stationary component (9).

10. A differential gearbox (3) comprising:
the differential locking device according to claim 1;
an input element (11);
a first output element (15); and
a second output element (16);
wherein the input element (11) is configured to introduce a drive power into the differential gearbox (3); and
wherein the differential gearbox (3) is configured to divide the drive power from the input element (11) between the first output element (15) and the second output element (16).

11. The differential gearbox according to claim 10, wherein the differential gearbox is in the form of a bevel gear differential gearbox.

12. A vehicle comprising:
the differential gearbox according to claim 10;
a drive unit (1); and
two drive elements;
wherein the drive unit (1) comprises a driveshaft (2) for supplying a drive power, which driveshaft is mechanically functionally connected to the input element (11) of the differential gearbox (3); and
wherein in order to power the vehicle, one of the drive elements is mechanically functionally connected to the first output element and the other one of the drive elements is mechanically functionally connected to the second output element.
